(19) United States
(12) Patent Application Publication
(10) Pub. No.: US 2024/0076755 A1
(43) Pub. Date: Mar. 7, 2024

(54) TOP-BLOWING LANCE FOR CONVERTER, METHOD FOR ADDING AUXILIARY RAW MATERIAL, AND METHOD FOR REFINING OF MOLTEN IRON

(71) Applicant: JFE STEEL CORPORATION, Tokyo (JP)

(72) Inventors: Shota AMANO, Tokyo (JP); Hidemitsu NEGISHI, Tokyo (JP); Yumi MURAKAMI, Tokyo (JP); Futoshi OGASAWARA, Tokyo (JP); Kenji NAKASE, Tokyo (JP)

(73) Assignee: JFE STEEL CORPORATION, Tokyo (JP)

(21) Appl. No.: 18/272,474

(22) PCT Filed: Dec. 2, 2021
(86) PCT No.: PCT/JP2021/044302

§ 371 Date: Jul. 14, 2023

(30) Foreign Application Priority Data
Feb. 1, 2021 (JP) 2021-014526

(51) Int. Cl. C21C 7/00; C21C 5/35; C21C 5/46; C21C 7/068

(52) U.S. Cl. CPC C21C 7/0037; C21C 5/35; C21C 5/4606; C21C 7/068

(57) ABSTRACT

A method that, regarding a process of refining molten iron, can increase the thermal margin and the amount of cold iron source to be used. A burner having jetting holes for jetting a fuel and a combustion supporting gas is provided at a leading end part of one lance that top-blows an oxidizing gas to molten iron contained in a converter-type vessel, or at a leading end part of another separate lance. A powdery auxiliary raw material or an auxiliary raw material processed into a powder form that is blown into the molten iron from the one lance or the other lance passes through a flame formed by the burner. This top-blowing lance for a converter is configured to secure a predetermined heating time and powder-fuel ratio. Also, a method for adding an auxiliary raw material and a method for refining of molten iron that use this top-blowing lance.

### Technical Field

The present invention relates to a top-blowing lance for a converter, a method for adding an auxiliary raw material, and a method for refining of molten iron, and relates particularly to a method that, in a process of refining molten iron contained in a converter-type vessel, increases the thermal margin and increases the amount of cold iron source to be used.

### BACKGROUND ART

A steelmaking method has developed so far in which a dephosphorization process is performed at the stage of molten pig iron (hereinafter referred to as a preliminary dephosphorization process) to reduce the concentration of phosphorus in molten pig iron to some extent before decarburization blowing is performed in a converter. In the preliminary dephosphorization process, an oxygen source, such as gaseous oxygen or solid oxygen, is added into the molten pig iron along with a lime-based flux, so that the oxygen source reacts with carbon and silicon in addition to reacting with phosphorus in the molten pig iron, causing a rise in temperature of the molten pig iron.

From the viewpoint of preventing global warming, the steelmaking industry has in recent years also been promoting efforts to reduce the amount of CO₂ gas generation by reducing the amount of fossil fuel consumption. In iron manufacturing, molten pig iron is manufactured by reducing iron ore with carbon. Manufacturing molten pig iron requires, for reducing iron ore etc., about 500 kg of carbon source per ton of molten pig iron. On the other hand, in the case of manufacturing molten steel using a cold iron source, such as iron scrap, as a raw material in a converter, there is no need for a carbon source that is needed to reduce iron ore. In this case, even when the energy required to melt the cold iron source is taken into account, substituting one ton of cold iron source for one ton of molten pig iron leads to a reduction of about 1.5 tons of the amount of CO₂ gas generation. Thus, in a converter steelmaking method using molten iron, increasing the mixing ratio of a cold iron source leads to a reduction of the amount of CO₂ generation. Here, molten iron refers to molten pig iron and a melted cold iron source.

To increase the amount of cold iron source to be used, it is necessary to supply an amount of heat required to melt the cold iron source. As mentioned above, heat for melting the cold iron source is normally compensated for by the reaction heat of carbon and silicon that are contained as impurity elements in molten pig iron. However, when the mixing ratio of the cold iron source is increased, the amount of heat derived from carbon and silicon contained in molten pig iron alone does not suffice.

For example, Patent Literature 1 proposes a method that compensates for heat to melt a cold iron source by supplying heating agents such as ferrosilicon, graphite, and coke into a furnace, and supplying an oxygen gas along with the heating agents.

In the aforementioned preliminary dephosphorization process, the temperature upon completion of the process is about 1300° C., which is a temperature lower than the melting point of iron scrap used as the cold iron source. In preliminary dephosphorization blowing, therefore, carbon contained in the molten pig iron is diffused into a surface layer part of the iron scrap, so that the melting point of the carburized part decreases and melting of the iron scrap progresses. Thus, promoting mass transfer of carbon contained in molten pig iron is important for promoting melting of iron scrap.

For example, Patent Literature 2 proposes a method that promotes melting of a cold iron source by promoting stirring of molten iron inside a converter through supply of a bottom-blown gas.

Patent Literatures 3 and 4 disclose smelting and reduction methods in which a lance for feeding auxiliary raw materials is installed separately from a top-blowing lance that is installed on a central axis of an iron bath-type smelting and reduction furnace and supplies an oxidizing gas. In that lance, a powder nozzle that jets powdery granular ore and metal oxides and a burner composed of a gaseous fuel nozzle and an oxygen gas nozzle are disposed concentrically. Ore and metal oxides are charged into the iron bath-type smelting and reduction furnace so as to pass through a flame generated from the burner.

### CITATION LIST

### Patent Literature

Patent Literature 1: JP-2011-38142A
Patent Literature 2: JP-S63-169318A
Patent Literature 3: JP-2007-138207A
Patent Literature 4: JP-2008-179876A

### Non Patent Literature

Non Patent Literature 1: Handbook of Scientific Tables
Non Patent Literature 2: The Japan Society of Mechanical Engineers, Heat Transfer, the revised fourth edition, 1986
Non Patent Literature 3: The Japan Institute of Metals and Materials, Metal Refining, 2000

### SUMMARY OF INVENTION

### Technical Problem

However, the above-described conventional methods have the following problems.

In the method described in Patent Literature 1, since an oxygen gas required to oxidize and combust carbon and silicon of the supplied heating agents is supplied for thermal compensation, the processing time in the converter increases, resulting in reduced productivity. Another problem is that the slag discharge amount increases as combustion of silicon generates SiO₂.

Increasing the force of stirring the molten pig iron as described in Patent Literature 2 can be expected to have a melting promoting effect and thereby increase the productivity. However, this method does not supply an amount of heat required to melt the cold iron source, and therefore cannot increase the amount of cold iron source to be used.

The methods of Patent Literatures 3 and 4 do not go so far as to take into account the form of heat transfer while the auxiliary raw materials pass through the burner flame. Since only the powder-fuel ratio is specified, these methods cannot be said to be able to optimize the thermal margin, e.g., heat transfer by the burner, by appropriately controlling operating parameters, including the lance height, that are considered to contribute to heat transfer efficiency.

Having been contrived in view of these circumstances, the present invention aims to provide a method that, regarding a process of refining molten iron contained in a converter-type vessel, can increase the thermal margin and increase the amount of cold iron source to be used.

### Solution to Problem

A top-blowing lance for a converter according to the present invention that advantageously solves the above-described challenges is characterized in that: a burner having jetting holes for jetting a fuel and a combustion supporting gas is provided at a leading end part of one lance that top-blows an oxidizing gas to molten iron contained in a converter-type vessel, or at a leading end part of another lance that is installed separately from the one lance; a powdery auxiliary raw material or an auxiliary raw material processed into a powder form that is blown into the molten iron from the one lance or the other lance passes through a flame formed by the burner; and the top-blowing lance is configured to secure a predetermined heating time as well as a predetermined powder-fuel ratio.

The top-blowing lance for a converter according to the present invention could be a more preferable solution when it has specifications such as follows:
(1) A distance lₕ (m) from a leading end of the lance having the burner to a molten metal surface and a discharge speed uₚ (m/s) of powder constituting the powdery auxiliary raw material or the auxiliary raw material processed into a powder form are determined so as to meet Expression 1 below, and a supply flow rate Q_{fuel} (Nm³/min) of the fuel and a supply amount Vₚ (kg/min) of the auxiliary raw material per unit time are determined so as to meet the relationship of Expression 2 below. (In these expressions, t₀ represents a required heating time (s) obtained from a particle diameter of the powdery auxiliary raw material or the auxiliary raw material processed into a powder form, H_{combustion} represents an amount of heat (MJ/Nm³) generated by fuel combustion, and C₀ represents a constant (kg/MJ).)
(2) The required heating time t₀ of the powdery auxiliary raw material or the auxiliary raw material processed into a powder form is determined from a particle diameter dₚ of the powdery auxiliary raw material or the auxiliary raw material processed into a powder form, an adiabatic flame temperature of the fuel, a flow velocity of a combustion gas of the fuel, and the discharge speed uₚ of the powder.
(3) The constant C₀ in Expression 2 is determined by the type of fuel gas to be used.

$$\begin{matrix}[ Expression 1 ] & \\ \frac{{l}_{h}}{{u}_{p}} \geq {t}_{0} & ( 1 )\end{matrix}$$

$$\begin{matrix}[ Expression 2 ] & \\ \frac{{V}_{p}}{{Q}_{fuel} \cdot {H}_{combustion}} \geq {C}_{0} & ( 2 )\end{matrix}$$

A method for adding an auxiliary raw material according to the present invention that advantageously solves the above-described challenges is a method for adding an auxiliary raw material when performing a refining process on molten iron contained in a converter-type vessel by supplying an oxidizing gas to the molten iron, characterized in that, using the top-blowing lance for a converter according to any one of claims 1 to 4, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

A method for refining of molten iron according to the present invention that advantageously solves the above-described challenges is a method for performing a refining process on molten iron contained in a converter-type vessel by adding an auxiliary raw material and supplying an oxidizing gas to the molten iron, characterized in that, using the top-blowing lance for a converter according to any one of claims 1 to 4, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

### Advantageous Effects of Invention

According to the present invention, a burner having jetting holes for jetting a fuel and a combustion supporting gas is provided at a leading end part of a lance that top-blows an oxidizing gas or at a leading end part of another lance installed separately from that lance. A powdery auxiliary raw material or an auxiliary raw material processed into a powder form is blown into molten iron so as to pass through a flame formed by this burner, and the auxiliary raw material is subjected to heating for a predetermined heating time or longer and jetted at a predetermined powder-fuel ratio. Thus, the powdery auxiliary raw material is sufficiently heated by the burner flame and turned into a heat transfer medium, so that heat can be efficiently transferred to the molten iron inside the converter. As a result, the heat transfer efficiency increases, and less of a carbon source and a silicon source fed as heating agents is required, which makes it possible to shorten the processing time and reduce the slag generation amount. Another advantage is that, as the powder supplied as a flux raw material is heated, the time taken to melt the slag is shortened and the metallurgical efficiency increases.

### BRIEF DESCRIPTION OF DRAWINGS

FIG. 1 is a schematic vertical sectional view showing an overview of a converter used in embodiments of the present invention.

FIG. 2 is schematic views of a burner according to one embodiment of the present invention, with FIG. (a) showing a vertical sectional view of a leading end of a lance, and FIG. (b) showing a bottom view of jetting holes as seen from below.

FIG. 3 is a graph showing a relationship between a powder-fuel ratio V/QH and heat transfer efficiency in the case where powder was supplied after being heated using the burner of the embodiment.

FIG. 4 is a graph showing an influence of a distance lₕ from a lance leading end to a molten metal surface on a relationship between a powder particle diameter dₚ and heat transfer efficiency in the case where powder was supplied after being heated using the burner of the embodiment.

FIG. 5 is a graph showing changes over time in particle temperature and combustion gas temperature for each powder particle diameter dₚ in the case where powder was supplied after being heated using the burner of the embodiment.

FIG. 6 is a graph showing suitable ranges of the present invention in a relationship between the powder-fuel ratio V/QH and an in-flame retention time lₕ/uₚ of powder.

### DESCRIPTION OF EMBODIMENTS

Embodiments of the present invention will be specifically described below. The drawings are schematic and may differ from the reality. The following embodiments exemplify a device and a method for embodying the technical idea of the present invention, and are not intended to limit the configuration to the one described below. Thus, various changes can be made to the technical idea of the present invention within the technical scope described in the claims.

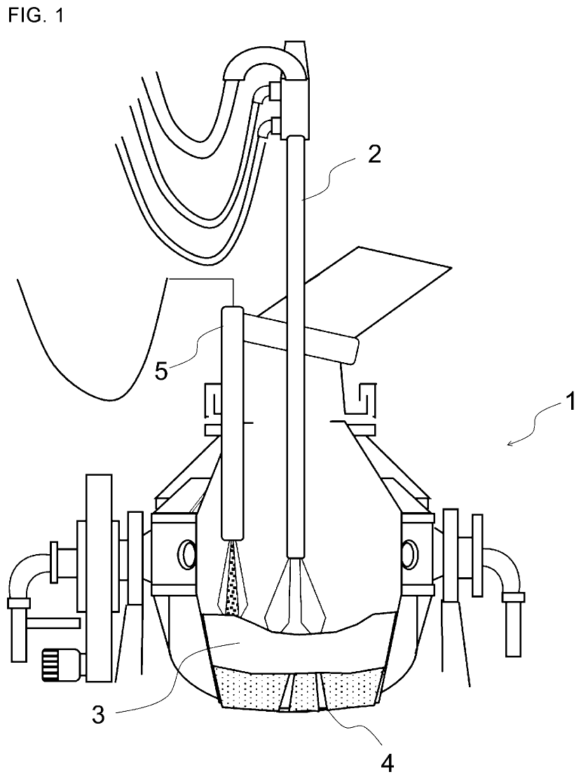

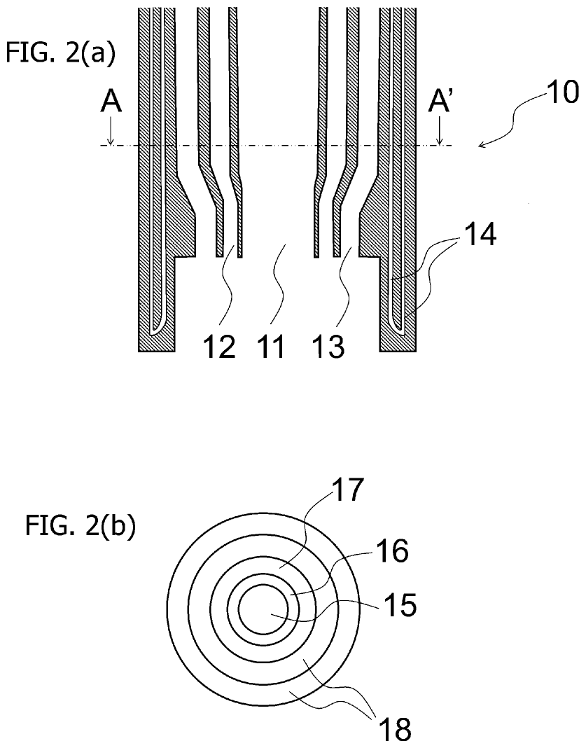

FIG. 1 is a schematic vertical sectional view of a converter-type vessel 1 having a top and bottom blowing function and used in a method for refining of molten iron of one embodiment of the present invention. FIG. 2 is schematic views of a leading end of a lance showing the structure of a burner having a powder supply function, with FIG. 2 (a) representing a vertical sectional view and FIG. 2 (b) being a view of section A-A′.

For example, first, iron scrap as a cold iron source is charged into the converter-type vessel 1 through a scrap chute (not shown). Then, molten pig iron is charged into the converter-type vessel 1 using a charging ladle (not shown).

After the molten pig iron is charged, an oxygen gas is top-blown toward molten iron 3 from one lance 2 that is configured to top-blow an oxidizing gas. An inert gas, such as argon or N₂, is supplied as a stirring gas from a tuyere 4 installed at the furnace bottom to thereby stir the molten iron 3. Then, auxiliary raw materials, such as a heating agent and a slag forming material, are added, and a dephosphorization process is performed on the molten iron 3 inside the converter-type vessel 1. Meanwhile, a powdery auxiliary raw material or an auxiliary raw material processed into a powder form (hereinafter, both may be collectively referred to as a “powdery auxiliary raw material”), such as lime powder, is supplied, using a carrier gas, through a powder supply pipe provided in the one lance 2 that top-blows an oxidizing gas or a powder supply pipe provided in another lance 5 that is installed separately from the one lance. Here, a burner having jetting holes for jetting a fuel and a combustion supporting gas is further provided at a leading end part of the one lance 2 or a leading end part of the other lance 5 installed separately from the one lance 2. During at least a part of the period of the dephosphorization process, the powdery auxiliary raw material supplied through the powder supply pipe is blown in so as to pass through a flame formed by this burner. FIG. 2 shows a schematic view of the leading end part of the lance 5 in the case where the lance 5 is installed separately from the one lance 2 and the burner is provided at the leading end of the lance 5. A powder supply pipe 11 having a jetting hole is disposed at the center, and a fuel supply pipe 12 and a combustion supporting gas supply pipe 13 both having a jetting hole are disposed in this order around the powder supply pipe 11. On the outer side, an outer shell having a cooling water passage 14 is provided. A fuel gas 16 and a combustion supporting gas 17 are supplied through the jetting holes provided in an outer periphery of the powder supply pipe 11 to form a burner flame. Then, the powdery auxiliary raw material (powder 15) is heated inside this burner flame. This turns the powdery auxiliary raw material into a heat transfer medium, so that the efficiency of heat transferred into the molten iron can be increased. As a result, the amount of heating agent to be used, such as a carbon source and a silicon source, can be reduced, and an increase in the dephosphorization process time can be avoided. To efficiently transfer heat to the powder, it is important to secure a time for which the powder 15 is retained inside the burner flame. As the oxidizing gas, other than pure oxygen, a mixture gas of oxygen with CO₂ or an inert gas can be used. As the combustion supporting gas, air, oxygen-enriched air, or an oxidizing gas can be used. As the fuel to be supplied, a fuel gas, such as a liquefied natural gas (LNG) or a liquefied petroleum gas (LPG), a liquid fuel, such as heavy oil, or a solid fuel, such as coke powder, can be used. From the viewpoint of reducing the amount of CO₂ generation, a fuel with less carbon source is preferable.

Using a converter-type vessel, the present inventors conducted a test of heating lime powder by a burner, with the flow rate of the carrier gas and the height of the lance changed to various values. As a result, we found that setting the retention time of powder in the burner flame to approximately 0.05 s to 0.1 s could achieve high heat transfer efficiency. For securing the in-flame retention time, reducing the flow velocity of the powder is effective. However, transporting the powder through a pipe requires supplying the carrier gas at a certain flow rate. Under realistic operation conditions, the flow velocity of the powder is within a range of 30 m/s to 60 m/s. Therefore, to secure the in-flame retention time, it is desirable to set the powder discharge hole (the leading end of the burner lance) to the position of a height (a lance height) of about 2 to 4 m from the molten iron surface. Details will be described below.

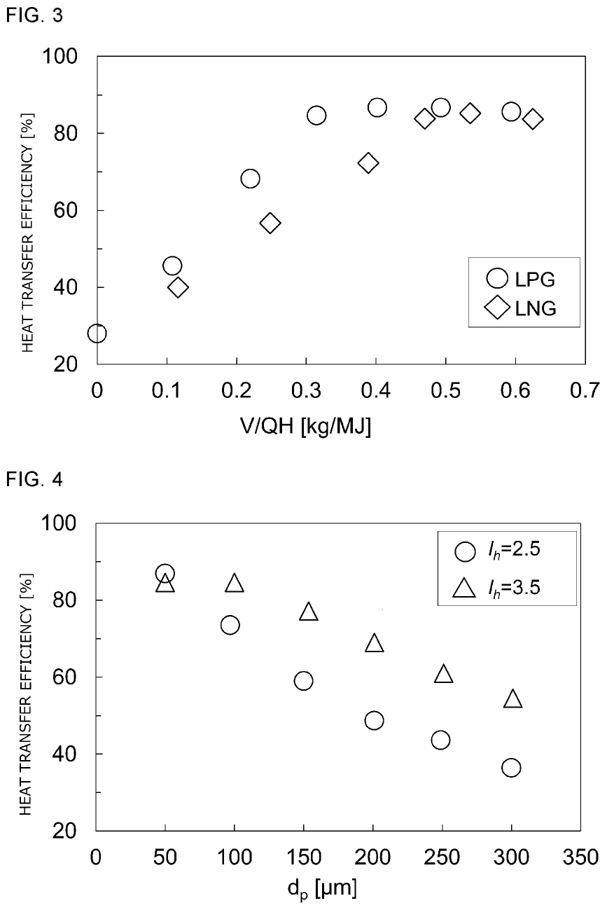

In the device configuration of FIG. 1, CaO powder having a mean particle diameter of 50 μm was supplied as a powdery auxiliary raw material to a 330-ton-scale converter-type vessel 1 from the burner lance 5 at 500 kg/min. FIG. 3 shows an influence on the heat transfer efficiency of changing a powder-fuel ratio (V/QH) by changing the flow rate of the fuel gas 16 in this case. Here, the powder-fuel ratio (V/QH) is, as shown in Formula (2) of Expression 3 below, obtained by dividing the amount of powdery auxiliary raw material supplied per unit time by the product of the supply flow rate of the fuel and the amount of heat generated by fuel combustion. The heat transfer efficiency (%) is expressed as a percentage of an amount of heat transfer (MJ) as calculated from a change in the molten iron temperature relative to an amount of heat input (MJ) due to combustion of the fuel gas. The same applies hereinafter. Increasing the powder-fuel ratio resulted in increased heat transfer efficiency. This demonstrates that the heat transfer efficiency increases when heat generated by burner combustion is input into the powder and the heated powder is brought into the molten iron. It has been shown that obtaining such an increasing effect on the heat transfer efficiency requires maintaining appropriate amounts of gas and powder inside the burner flame. It has been shown that when the powder is too little relative to the flame gas, the heat transfer efficiency decreases as the ratio of heat discharged to the outside of the furnace as gas sensible heat increases. Next, as for the influence of the gas type, as has been clarified by FIG. 3, when an LPG is used, the heat transfer efficiency becomes constant at a powder-fuel ratio of 0.3 kg/MJ or higher. When an LNG is used, the heat transfer efficiency becomes constant at a powder-fuel ratio of 0.45 kg/MJ or higher. Therefore, it is necessary to control the powder-fuel ratio according to the type of fuel gas to be used. That is, Formula (2) below needs to be met. In Formula (2), V/QH represents a powder-fuel ratio (kg/MJ); Vₚ represents an amount of powdery auxiliary raw material supplied per unit time (kg/min); Q_{fuel} represents a supply flow rate (Nm³/min) of the fuel; H_{combustion} represents an amount of heat (MJ/Nm³) generated by fuel combustion; and C₀ represents a constant (kg/MJ) determined by the type of fuel gas to be used. The upper limit of the powder-fuel ratio is determined by a condition under which the temperature of the heated powder becomes equal to or lower than the molten iron temperature.

$$\begin{matrix}[ Expression 3 ] & \\ V / QH = \frac{{V}_{p}}{{Q}_{fuel} \cdot {H}_{combustion}} \geq {C}_{0} & ( 2 )\end{matrix}$$

In the device configuration of FIG. 1, CaO was supplied as a powdery auxiliary raw material to a 330-ton-scale converter-type vessel 1 from the burner lance 5 at 700 kg/min. FIG. 4 shows an influence exerted on the heat transfer efficiency by the mean particle diameter dₚ (μm) of the powder and the distance (lₕ) from the leading end of the lance to the molten metal surface in this case. An LPG was used as the fuel gas, and the powder-fuel ratio (V/QH) was set to 0.5 kg/MJ. The heat transfer efficiency was found to decrease as the mean particle diameter of the CaO powder increased, and at the same particle diameter, the heat transfer efficiency was higher when the lance height was greater. The discharge flow velocity of the powder was within a range of 30 to 60 m/s.

A possible explanation is that how much the powder was heated while the powder was passing through the burner flame had an influence. Therefore, temperature transition of the powder passing through the flame was estimated by the following method with reference to Non Patent Literatures 1 to 3. A specific heat capacity C_{p, P} of the powder was 1004 J/(kg·K); a particle density ρ was 3340 kg/m³; a particle radiation factor εₚ was 0.9; and heat conductivity λ of the gas was 0.03 W/(m·K). The fuel gas was an LPG, and the powder supply speed/fuel flow rate (V/Q) was set to 100 kg/Nm³. The combustion reaction is based on Chemical Reactions (a) to (e) shown in Chemical Formulae 1 to 5 below. The equilibrium constant Kᵢ of each reaction can be obtained by a partial pressure P_{G} (G is a chemical formula of the gas type) of a gas involved in the reaction (i). Here, the suffix i represents Chemical Reaction Formulae (a) to (e) shown in Chemical Formulae 1 to 5 below. A total pressure P inside the combustion flame is, as the sum of the partial pressures of the respective gas types, 1 atm in total as in Formula (3) shown in Expression 4 below.

$$\begin{matrix}[ Formula 1 ] & \\ \begin{matrix}{CO}_{2} ↔ CO + \frac{1}{2} {O}_{2} & ( {K}_{a} = \frac{{P}_{C O} \cdot {P}_{{O}_{2}}^{1 / 2}}{{P}_{C {O}_{2}}} )\end{matrix} & ( a )\end{matrix}$$

$$\begin{matrix}[ Formula 2 ] & \\ \begin{matrix}{H}_{2} O ↔ {H}_{2} + \frac{1}{2} {O}_{2} & ( {K}_{b} = \frac{{P}_{{H}_{2}} \cdot {P}_{{O}_{2}}^{1 / 2}}{{P}_{{H}_{2} O}} )\end{matrix} & ( b )\end{matrix}$$

$$\begin{matrix}[ Formula 3 ] & \\ \begin{matrix}{H}_{2} O ↔ \frac{1}{2} {H}_{2} + OH & ( {K}_{c} = \frac{{P}_{O H} \cdot {P}_{{H}_{2}}^{1 / 2}}{{P}_{{H}_{2} O}} )\end{matrix} & ( c )\end{matrix}$$

$$\begin{matrix}[ Formula 4 ] & \\ \begin{matrix}\frac{1}{2} {H}_{2} ↔ H & ( {K}_{d} = \frac{{P}_{H}}{{P}_{{H}_{2}}^{1 / 2}} )\end{matrix} & ( d )\end{matrix}$$

$$\begin{matrix}[ Formula 5 ] & \\ \begin{matrix}\frac{1}{2} {O}_{2} ↔ O & ( {K}_{e} = \frac{{P}_{O}}{{P}_{{O}_{2}}^{1 / 2}} )\end{matrix} & ( e )\end{matrix}$$

$$\begin{matrix}[ Expression 4 ] & \\ P ≡ {P}_{CO} + {P}_{{CO}_{2}} + {P}_{{O}_{2}} + {P}_{{H}_{2}} + {P}_{{H}_{2} O} + {P}_{O H} + {P}_{H} + {P}_{O} = 1 atm & ( 3 )\end{matrix}$$

Formula (4) is a formula for calculating an equilibrium flame temperature. The equilibrium flame temperature was estimated by a trial-and-error method such that the difference between an enthalpy change of the particles (H⁰−H⁰₂₉₈)ₚ from a base temperature to the equilibrium flame temperature and an enthalpy change of the gas (H⁰−H⁰₂₉₈)_{g} from the base temperature to the equilibrium flame temperature became equal to an enthalpy change (−ΔH⁰₂₉₈) due to the gas reactions (a) to (e) that meets Formula (3).

Formula (5) is a formula that estimates a change in temperature of the particles as the sum of a heat input due to heat transfer and a heat input due to radiation.

Formula (6) is a formula for obtaining a heat flux of heat transfer.

Formula (7) is a formula for obtaining a heat flux of radiation.

Formula (8) is a formula that expresses a dimensionless relationship relating to forced convection with the flame as a heat fluid. Symbols Nu, Reₚ, and Pr represent a Nusselt number, a Reynolds number, and a Prandtl number, respectively.

Symbol m is the mass (kg) of the powder; C_{p, P} is the specific heat capacity (J/(kg·K)) of the powder; A_{S, P} is the surface area (m²) of the particles; T_{g} and Tₚ are respectively the gas temperature and the particle temperature (K); qₚ and q_{R} are respectively a convection heat transfer term and a radiation heat transfer term; λ is the heat conductivity (W/(m·K)) of the gas; d is the particle diameter as a representative length; εₚ is the radiation factor (−) of the particles; and σ is a Stefan-Bolzmann coefficient. The powder temperature Tₚ was calculated by the fourth-order Runge-Kutta method.

$$\begin{matrix}[ Expression 5 ] & \\ {( {H}^{0} - {H}_{298}^{0} )}_{P} = {( {H}^{0} - {H}_{298}^{0} )}_{g} - Δ {H}_{298}^{0} & ( 4 )\end{matrix}$$

$$\begin{matrix}[ Expression 6 ] & \\ {mC}_{p , P} \frac{d ( {T}_{P} )}{d t} = {A}_{S , P} \cdot {q}_{P} + {A}_{S , P} \cdot {q}_{R} & ( 5 )\end{matrix}$$

$$\begin{matrix}[ Expression 7 ] & \\ {q}_{P} = \frac{N u λ}{d} ( {T}_{g} - {T}_{P} ) & ( 6 )\end{matrix}$$

$$\begin{matrix}[ Expression 8 ] & \\ {q}_{R} = {ε}_{P} \cdot σ ( {T}_{g}^{4} - {T}_{P}^{4} ) & ( 7 )\end{matrix}$$

$$\begin{matrix}[ Expression 9 ] & \\ Nu = 2 + 0.6 \cdot R {e}_{P}^{1 / 2} {Pr}^{1 / 3} & ( 8 )\end{matrix}$$

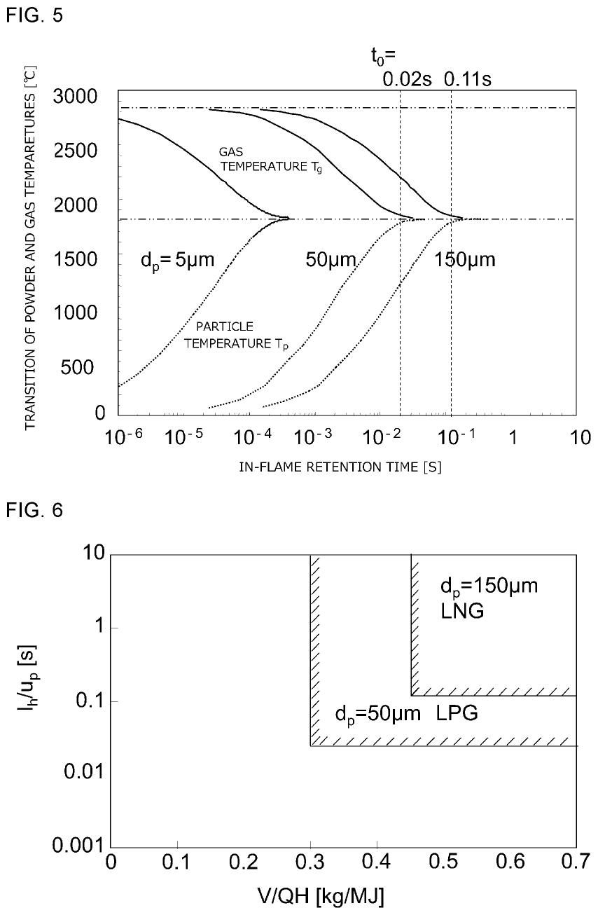

FIG. 5 shows the influence of the particle diameter dₚ, as estimated by the above relational expressions, on the relationship between the change in the combustion gas temperature T_{g} and the change in the particle temperature Tₚ in the case where the powder passes through the flame. As can be seen from FIG. 5, the time taken for the temperature Tₚ of the powder inside the flame to become equal to the gas temperature T_{g} on the flame side varies greatly with the particle diameter dₚ. A required heating time t₀ of the powdery auxiliary raw material can be set, for example, to such a time that the difference between the gas temperature T_{g} and the particle temperature Tₚ becomes 10° C. or smaller. Specifically, it is important that the powder discharge speed uₚ and the lance height lₕ meet the relationship of the following Formula (1), to control the heat transfer efficiency.

$$\begin{matrix}[ Expression 10 ] & \\ \frac{{l}_{h}}{{u}_{p}} \geq {t}_{0} & ( 1 )\end{matrix}$$

To sufficiently heat the powdery auxiliary raw material by the flame of the burner, the burner lance 5 constituting the top-blowing lance for the converter of this embodiment is configured such that, for example, the lance height lₕ can be adjusted so as to set the in-flame retention time (lₕ/uₚ) of the powder to be equal to or longer than the required heating time t₀. The required heating time t₀ can be calculated, using the above estimation formula, from the particle diameter dₚ of the powdery auxiliary raw material, the adiabatic flame temperature of the fuel, the flow velocity of the combustion gas of the fuel, and the powder discharge speed uₚ. The lance height lₕ is subject to a facility restriction that prohibits the leading end of the lance from sticking out beyond the throat. An appropriate range of the powder discharge speed uₚ is obtained from the viewpoint of stably delivering the powder by a carrier gas. For example, the nozzle diameter of the burner lance 5 is designed such that the powder-fuel ratio (V/QH) can meet the above Formula (2).

FIG. 6 shows suitable ranges based on Formula (1) and Formula (2). In FIG. 6, the axis of abscissas represents the powder-fuel ratio V/QH (kg/MJ) and the axis of ordinates represents the in-flame retention time lₕ/uₚ (s) of the powder. The hatched areas indicate suitable ranges in the case where the powder particle diameter dₚ is 50 μm and the fuel gas type is an LPG and the case where the powder particle diameter dₚ is 150 μm and the fuel gas type is an LNG.

### EXAMPLES

Using a 300-ton-capacity top and bottom blowing converter (with an oxygen gas top-blown and an argon gas bottom-blown) of the same form as the converter-type vessel 1 shown in FIG. 1, decarburization refining of molten iron was performed. As the top-blowing lance 2 for blowing oxygen, a lance having five Laval nozzle-type jetting nozzles at the leading end part was used. The top-blowing lance 2 used had the nozzles disposed at regular intervals on the same circumference relative to the axial center of the lance, with the jetting angle of the nozzles set to 15°. The jetting nozzles had a throat diameter dt of 73.6 mm and an outlet diameter de of 78.0 mm.

First, iron scrap was charged into the converter. Then, 300 tons of molten pig iron that had been subjected to a desulfurization process and a dephosphorization process in advance was charged into the converter. Table 1 shows the chemical components of the molten pig iron and the temperature of the molten pig iron.

TABLE 1

| | | | | | | | Molten pig iron |
|---|---|---|---|---|---|---|---|
| Chemical components of molten pig iron (mass %) | | | | | | | temperature |
| C | Si | Mn | P | S | Cr | Fe | (° C.) |
| 3.4 to | 0.01 to | 0.16 to | 0.015 to | 0.008 to | tr | bal. | 1310 to 1360 |
| 3.6 | 0.02 | 0.27 | 0.036 | 0.016 | | | |

Next, while an argon gas was blown into the molten iron 3 as a stirring gas from the bottom blowing tuyere 4, an oxygen gas was blown onto the bath surface of the molten iron 3 as an oxidizing gas from the top-blowing lance 2 to start decarburization refining of the molten iron 3. The amount of iron scrap to be charged was adjusted such that molten steel upon completion of decarburization refining had a temperature of 1650° C.

Then, quicklime was fed as a CaO-based flux during decarburization refining from the burner lance 5 for feeding auxiliary raw materials, and decarburization refining was performed until the concentration of carbon in the molten iron became 0.05% by mass. The amount of quicklime to be fed was adjusted such that the basicity ((mass % CaO)/(mass % SiO₂)) of slag generated inside the furnace became 2.5. An LNG was used as the fuel gas, and the flow rate of the oxygen gas for combusting the fuel was controlled so as to achieve an air-fuel ratio of 1.2. The powder supply speed uₚ, the fuel gas flow rate Q_{fuel}, and the lance height lₕ of the burner lance 5 for feeding auxiliary raw materials were controlled as shown in Table 2.

TABLE 2

| | | | | | | | | | Amount | Amount | Heat | |
|---|---|---|---|---|---|---|---|---|---|---|---|---|
| | | | | | | | | | of heat | of heat | transfer | |
| | dₚ | uₚ | lₙ | lₙ/uₚ | tₒ | Vₚ | Q | V/QH | input | transfer | efficiency | |
| No. | μm | m/s | m | s | s | kg/min | N m³/min | kg/MJ | MJ/t | MJ/t | % | Remarks |
| 1 | 50 | 30 | 2.5 | 0.08 | 0.02 | 700 | 35 | 0.48 | 36.0 | 29.2 | 81 | Invention Example |
| 2 | 50 | 60 | 4.0 | 0.07 | 0.02 | 700 | 35 | 0.48 | 36.0 | 29.9 | 83 | Invention Example |
| 3 | 50 | 60 | 4.0 | 0.07 | 0.02 | 700 | 25 | 0.67 | 25.7 | 21.1 | 82 | Invention Example |
| 4 | 50 | 30 | 3.5 | 0.12 | 0.02 | 700 | 35 | 0.48 | 36.0 | 31.7 | 88 | Invention Example |
| 5 | 100 | 30 | 3.5 | 0.12 | 0.06 | 700 | 25 | 0.67 | 25.7 | 22.3 | 87 | Invention Example |
| 6 | 100 | 60 | 3.5 | 0.06 | 0.06 | 500 | 25 | 0.48 | 25.7 | 20.8 | 81 | Invention Example |
| 7 | 150 | 30 | 3.5 | 0.12 | 0.11 | 700 | 25 | 0.67 | 25.7 | 22.3 | 87 | Invention Example |
| 8 | 50 | 30 | 2.5 | 0.08 | 0.02 | 350 | 35 | 0.24 | 36.0 | 14.0 | 39 | Comparative Example |
| 9 | 50 | 30 | 2.5 | 0.08 | 0.02 | 500 | 35 | 0.34 | 36.0 | 15.5 | 43 | Comparative Example |
| 10 | 100 | 50 | 2.0 | 0.04 | 0.06 | 700 | 25 | 0.67 | 25.7 | 13.4 | 52 | Comparative Example |
| 11 | 100 | 60 | 2.5 | 0.04 | 0.06 | 350 | 35 | 0.24 | 36.0 | 12.2 | 34 | Comparative Example |
| 12 | 150 | 30 | 3.0 | 0.10 | 0.11 | 350 | 35 | 0.24 | 36.0 | 22.0 | 61 | Comparative Example |
| 13 | 150 | 60 | 3.0 | 0.05 | 0.11 | 550 | 35 | 0.38 | 36.0 | 20.9 | 58 | Comparative Example |

As is clear from Table 2, the heat transfer efficiency in the examples of the present invention was dramatically increased relative to that in the comparative examples. Further, the status of slag formation in the sequence of operation was evaluated. The components of slag were analyzed and the concentrations of non-slagged CaO (% f—CaO) were compared. In processing conditions No. 1 to 7, (% f—CaO) was 0 to 0.05% by mass, whereas in processing conditions No. 10 to 13, (% f—CaO) was 0.4 to 2.6% by mass. Thus, the present invention was found to be also effective in promoting melting of CaO.

### INDUSTRIAL APPLICABILITY

The top-blowing lance for a converter, the method for adding an auxiliary raw material, and a method for refining of molten iron of the present invention increase the heat transfer efficiency, making it possible to shorten the processing time and reduce the slag generation amount. Moreover, the time taken to melt slag is shortened and metallurgical efficiency increases. These advantages make the present invention useful for industrial purposes. The present invention is suitably applied to processes not only in a converter type but also in electric furnaces etc. that require a heat source.

### REFERENCE SIGNS LIST

1 Converter-type vessel
2 Top-blowing lance for oxidizing gas
3 Molten iron
4 Bottom blowing tuyere
5 Burner lance
10 Leading end part of burner lance
11 Powder supply pipe
12 Fuel supply pipe
13 Combustion supporting gas supply pipe
14 Cooling water passage
15 Powder
16 Fuel
17 Combustion supporting gas
18 Cooling water

1. A top-blowing lance for a converter, wherein:
a burner having jetting holes for jetting a fuel and a combustion supporting gas is provided at a leading end part of one lance that top-blows an oxidizing gas to molten iron contained in a converter-type vessel, or at a leading end part of another lance that is installed separately from the one lance;
a powdery auxiliary raw material or an auxiliary raw material processed into a powder form that is blown into the molten iron from the one lance or the other lance passes through a flame formed by the burner; and
the top-blowing lance is configured to secure a predetermined heating time as well as a predetermined powder-fuel ratio.

2. The top-blowing lance for a converter according to claim 1, wherein
a distance lₕ (m) from a leading end of the lance having the burner to a molten metal surface and a discharge speed uₚ (m/s) of powder constituting the powdery auxiliary raw material or the auxiliary raw material processed into a powder form are determined so as to meet Expression 1 below, and a supply flow rate Q_{fuel} (Nm³/min) of the fuel and a supply amount Vₚ (kg/min) of the auxiliary raw material per unit time are determined so as to meet the relationship of Expression 2 below:
$$\begin{matrix}[ Expression 1 ] & \\ \frac{{l}_{h}}{{u}_{p}} \geq {t}_{0} & ( 1 )\end{matrix}$$
$$\begin{matrix}[ Expression 2 ] & \\ \frac{{V}_{p}}{{Q}_{fuel} \cdot {H}_{combustion}} \geq {C}_{0} & ( 2 )\end{matrix}$$
where t₀ represents a required heating time (s) obtained from a particle diameter of the powdery auxiliary raw material or the auxiliary raw material processed into a powder form,
H_{combustion} represents an amount of heat (MJ/Nm³) generated by fuel combustion, and
C₀ represents a constant (kg/MJ).

3. The top-blowing lance for a converter according to claim 2, wherein
the required heating time to of the powdery auxiliary raw material or the auxiliary raw material processed into a powder form is determined from a particle diameter dₚ of the powdery auxiliary raw material or the auxiliary raw material processed into a powder form, an adiabatic flame temperature of the fuel, a flow velocity of a combustion gas of the fuel, and the discharge speed uₚ of the powder.

4. The top-blowing lance for a converter according to claim 2, wherein
the constant C₀ in Expression 2 is determined by a type of fuel gas to be used.

5. A method for adding an auxiliary raw material when performing a refining process on molten iron contained in a converter-type vessel by supplying an oxidizing gas to the molten iron,
wherein,
using the top-blowing lance for a converter according to claim 1, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

6. A method for performing a refining process on molten iron contained in a converter-type vessel by adding an auxiliary raw material and supplying an oxidizing gas to the molten iron,
wherein,
using the top-blowing lance for a converter according to claim 1, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

7. The top-blowing lance for a converter according to claim 3, wherein
the constant C0 in Expression 2 is determined by a type of fuel gas to be used.

8. A method for adding an auxiliary raw material when performing a refining process on molten iron contained in a converter-type vessel by supplying an oxidizing gas to the molten iron,
wherein,
using the top-blowing lance for a converter according to claim 2, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

9. A method for adding an auxiliary raw material when performing a refining process on molten iron contained in a converter-type vessel by supplying an oxidizing gas to the molten iron,
wherein,
using the top-blowing lance for a converter according to claim 3, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

10. A method for adding an auxiliary raw material when performing a refining process on molten iron contained in a converter-type vessel by supplying an oxidizing gas to the molten iron,
wherein,
using the top-blowing lance for a converter according to claim 4, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

11. A method for adding an auxiliary raw material when performing a refining process on molten iron contained in a converter-type vessel by supplying an oxidizing gas to the molten iron,
wherein,
using the top-blowing lance for a converter according to claim 7, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

12. A method for performing a refining process on molten iron contained in a converter-type vessel by adding an auxiliary raw material and supplying an oxidizing gas to the molten iron,
wherein,
using the top-blowing lance for a converter claim 2, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

13. A method for performing a refining process on molten iron contained in a converter-type vessel by adding an auxiliary raw material and supplying an oxidizing gas to the molten iron,
wherein,
using the top-blowing lance for a converter claim 3, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

14. A method for performing a refining process on molten iron contained in a converter-type vessel by adding an auxiliary raw material and supplying an oxidizing gas to the molten iron,
wherein,
using the top-blowing lance for a converter claim 4, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.

15. A method for performing a refining process on molten iron contained in a converter-type vessel by adding an auxiliary raw material and supplying an oxidizing gas to the molten iron,
wherein,
using the top-blowing lance for a converter claim 7, a powdery auxiliary raw material or an auxiliary raw material processed into a powder form that is part of the auxiliary raw material is blown into the molten iron so as to pass through a flame formed by the burner, and the powdery auxiliary raw material or the auxiliary raw material processed into a powder form is heated for a predetermined heating time or longer and jetted at a predetermined powder-fuel ratio.
